(19) United States
(12) Patent Application Publication
(10) Pub. No.: US 2006/0153960 A1
(43) Pub. Date: Jul. 13, 2006

(54) Cakes comprising dietary fiber gel

(75) Inventors: Triveni P. Shukla, New Berlin, WI (US); Gregory J. Halpern, Vernon Hills, IL (US)

Correspondence Address: Circle Group Holdings, Inc., 1011 Campus Drive, Mundelein, IL, 60060, US

(73) Assignee: Circle Group Holdings, Inc.

(21) Appl. No.: 11/368,955

(22) Filed: Mar. 6, 2006

Related U.S. Application Data
(63) Continuation-in-part of application No. 10/878,912, filed on Jun. 28, 2004, now abandoned.

(51) Int. Cl. A21D 10/00

(52) U.S. Cl. 426/549

(57) ABSTRACT

According to the present invention, fat and caloric content of cakes can be reduced by the replacement of a portion fat content normally found in cakes with an equal amount of dietary fiber. The result is that fat and caloric content of cakes can be manipulated with minimal effect on taste and texture. Furthermore, the cakes can further comprise functional foods that increase health and nutritional benefits of the cakes. The functional foods can be added individually, and in any combination thereof. Hence, in addition to reducing fat and caloric content of cakes by replacing a portion of fat with dietary fiber gel, additional health benefits can be achieved with compositions that include functional foods.

### CROSS-REFERENCE TO RELATED APPLICATIONS

This application is a Continuation-in-Part Application of U.S. patent application No. 10/878,912 filed on Jun. 28, 2004, the entirety of which is incorporated herein by reference.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to reduced fat cakes comprising dietary fiber gel. Recent media attention to the global problem of obesity demonstrates a need for greater availability of foods with low caloric and fat content. This is especially true for foods that typically contain fat, such as cakes.

Cakes typically comprise some combination of flour, fat, and sugar. Other ingredients can vary according to the type of cake and the recipe followed, but typically, cakes are high in fat regardless of the recipe followed. In recent years, some companies have begun to offer reduced fat cakes. This variety of cake, however, often involves increased sugar concentrations in order to compensate for the less desirable taste resulting from lower fat concentrations. Thus, reduced fat cakes generally retain high caloric content.

Accordingly, there is a need for a reduced fat and caloric content cakes that retain the desirably flavor of high fat and high caloric content cake.

### BRIEF SUMMARY OF THE INVENTION

A composition of matter for use in producing high-fiber, low-calorie and low-fat cakes is provided. The composition includes dietary fiber gel that replaces fat in cakes. In addition, compositions are provided that include dietary fiber gel and other functional ingredients for nutritionally fortified cakes.

### DETAILED DESCRIPTION OF THE PREFERRED EMBODIMENT

The following description provides for the use of dietary fiber gels for fat and calorie reduced cakes. When substituted for fat containing compounds, dietary fiber gels reduce the fat and calorie content of food products.

Dietary fiber gels for calorie-reduced foods hold the key to meeting this need. Dietary fiber gels for calorie-reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. These amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, their high viscosity at low solid levels characterizes these dietary fiber gels. Other insoluble fibers derived from cereals, grains and legumes consist of morphologically in tact cellular structures, and thus impart a gritty texture to the foods in which they are contained. The amorphous insoluble cellulosic fiber gels disclosed in the '662 patent (also herein referred to as dietary fiber gels), however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

Dietary fiber gels are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Dietary fiber gel can be a gellable product or a gel powder depending on water content. Typically, dietary fiber gel is produced as a gellable product that is dried to remove water so as to produce a gel powder having reduced water content. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

According to the present invention, fat and caloric content can be reduced by the replacement of the fat-containing ingredients normally found in cakes with dietary fiber gel, such as shortening compositions comprising dietary fiber gel. Substituting dietary fiber gel for fat does not adversely affect either the taste or texture of the cakes.

Alternatively, the cakes can be provided in the form of cake mixes with the intention that a consumer can mix and bake them at a convenient, post-purchase time, and cake mixes are considered to be within the scope of this invention. Similarly, cakes can also be provided in the form of cake ingredients with the intention that a consumer can mix and bake them at a convenient, post-purchase time, and cake ingredients are considered to be within the scope of this invention. Also, dietary fiber gel cake formulations can be whipped for incorporation of air. As such, for purposes of this document, the term “cakes” is defined to include cake mixes, cake ingredients, and whipped cake formulations that incorporate air.

Different categories of cakes are available to consumers. Cakes can be formulated such that the cake comprises 0.2 percent to 5.0 percent dietary fiber gel solids by replacing an appropriate amount, that is, an amount prorated to deliver this range of dietary fiber gel solids, of fat, including oil and liquid shortening, with dietary fiber gel based substitutes. The result is that fat and caloric content of cakes can be manipulated with minimal adverse effect on taste and texture, and as stated above, additional health benefits can be achieved through consumption of cakes comprising dietary fiber gel when functional foods are included in the formulations.

Functional ingredients can be added to the composition of cakes to increase health and nutritional benefits of this food. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to the cakes.

The following ranges of the functional foods in cakes are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega three oils are used, their respective concentrations can be prorated to give an appropriate end concentration of high omega three fatty acids. Medium chain triglyceride can be added in concentrations ranging from 1 percent to 30 percent of the composition by weight. Fagopyritrol or foods containing fagopyritrol can be added in concentrations of 0.25 percent to 20 percent of the composition by weight. Polyphenolic antioxidants of vegetable origin, for example lycopene, beta carotene, luteine, and bioflavonoids can be added alone or in combination in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake recommendations by the FDA, European Commission, FAO, Codex Alimentarius, or other international authorities.

Although the present invention is illustrated by the example of cakes, cake mixes, cake ingredients, and so forth, the present invention applies to foods and food formulations that include fat containing ingredients such as oils, greases, and lards that are derived from vegetable, animal, or synthetically produced that are used in the mixing, baking, reheating or other processing as necessary to produce edible foods.

An advantage of the present invention is the ability to provide a unique composition of matter embodied by low-calorie and low-fat cakes. The fat and caloric content are advantageously reduced by the replacement of the fat normally found in cakes with compositions comprising dietary fiber gel. Food compositions that reduce caloric and fat content answer an unmet need in the food industry to provide the consuming public with a healthier, higher fiber alternative to traditional types of cakes that typically are inherently fattening. Another advantage is the providing cakes that have been fortified with insoluble fiber and other functional foods. Yet another advantage is that the fat replacement with dietary fiber gel does not adversely affect either the taste or texture of cakes. Finally, the fat and caloric content of cakes can be advantageously manipulated with minimal adverse effect on taste and texture, and additional health benefits can be achieved through composition of cakes comprising dietary fiber gel when functional foods are included in the formulations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### EXAMPLE 1

### Devil's Food Layer Cake

TABLE 1

Ingredients

| Item | % Fat | Control | w/Fiber Gel |
|---|---|---|---|
| Sugar | | 23.00 | 23.00 |
| Cake Flour | | 19.00 | 18.25 |
| Vegetable Shortening | 100.00 | 12.00 | 7.00 |
| Dutch Cocoa | 10.00 | 5.00 | 5.00 |
| Non Fat Dry Milk | 0.90 | 3.00 | 3.00 |
| Baking Soda | | 0.50 | 0.50 |
| Baking Powder | | 1.25 | 1.50 |
| Salt | | 1.00 | 1.00 |
| Whole Egg Powder | 40.95 | 5.00 | 4.00 |
| Vanilla | | 0.25 | 0.25 |
| Water | | 30.00 | 35.00 |
| Dietary fiber gel powder | | — | 1.50 |
| Total | | 100.00 | 100.00 |
| Percent Fat | | 14.58 | 9.16 |

### Procedure

1. Add dietary fiber gel and water (water only in case of control) and mix at high speed for 10 three minutes to make gel. Add melted shortening and whole egg powder and mix again at high speed for two minutes.
2. Blend and sift all dry ingredient and to the Kitchen-Aid mixer, a add gel in three installments mixing for three minutes after each installment of gel added. In case of dietary fiber gel cake, add very little water to adjust the cake batter consistency to resemble that of control.
3. Bake at 350 for 65 to 70 minutes,

I claim:

1. cake, the cake having a formulation, the cake comprising dietary fiber gel, wherein dietary fiber gel is added in a prorated amount such that solids contained within the dietary fiber gel represent 0.2 percent to 4.0 percent by weight of the overall cake formulation, and dietary fiber gel replaces an amount of fat used in an otherwise identical recipe of cake that uses no dietary fiber gel.

2. Cake of claim 1, further comprising flour.

3. Cake of claim 1, further comprising fat.

4. Cake of claim 1, wherein the cake is made from a cake mix.

5. Cake of claim 1, wherein the cake is made from cake ingredients.

6. The cake of claim 1, further comprising at least one functional food selected from a group consisting of
high omega three oil, wherein high omega three oil represents 1 percent to 50 percent of the cake by weight,
pure omega three fatty acid, wherein pure omega three fatty acid represents 1 percent to 30 percent of the cake by weight,
a combination of high omega three oil and pure omega three fatty acid, wherein the total omega three fatty acid present in the combination represents 1 percent to 30 percent of the cake by weight,
medium chain triglyceride, wherein medium chain triglyceride represents 1 percent to 30 percent of the cake by weight,
fagopyritrol, wherein fagopyritrol represents 0.25 percent to 20 percent of the cake by weight,
lycopene, wherein the lycopene represents 0.25 percent to 20 percent of the cake by weight,
polyphenolic antioxidants of vegetable origin, wherein polyphenolic antioxidants represent 0.25 percent to 20 percent of the cake by weight,
luteine, wherein the luteine represents 0.25 percent to 20 percent of the cake by weight, beta carotene, wherein the beta carotene represents 0.25 percent to 20 percent of the cake by weight,
calcium stearate, wherein the calcium stearate represents 0.25 percent to 20 percent of the cake by weight,
vitamin E, wherein the vitamin E represents 0.25 percent to 20 percent of the cake by weight, bioflavonoid, wherein the bioflavonoid represents 0.25 percent to 20 percent of the cake by weight,
a functional food having a daily intake reported by the United States Food and Drug Administration, wherein the cake contains 25 percent to 100 percent of prevailing daily intake recommendation by the United States Food and Drug Administration,
a functional food having a daily intake reported by the European Commission, wherein the cake contains 25 percent to 100 percent of prevailing daily intake recommendation by the European Commission,
a functional food having a daily intake reported by the FAO, wherein the cake contains 25 percent to 100 percent of prevailing daily intake recommendation by the FAO, and
a functional food having a daily intake reported by the Codex Alimentarius, wherein the cake contains 25 percent to 100 percent of prevailing daily intake recommendation by the Codex Alimentarius.
